(19) United States
(12) Patent Application Publication
(10) Pub. No.: US 2021/0044183 A1
(43) Pub. Date: Feb. 11, 2021

(54) METHOD FOR REPAIRING SOLDER JOINT LEAKAGES

(71) Applicant: Siemens Aktiengesellschaft, Munich (DE)

(72) Inventors: Sebastian Blachny, Duisburg (DE); Detlef Frerichs, Baden Baden (DE); Rene Höhner, Gelsenkirchen (DE); Robert Koch, Dormagen (DE); Michael Kretschmer, Oberhausen (DE); Markus Nalasko, Gelsenkirchen (DE); Jürgen Weidner, Essen (DE); Klaus Wunderlich, Mülheim an der Ruhr (DE)

(73) Assignee: Siemens Aktiengesellschaft, Munich (DE)

(21) Appl. No.: 16/968,579

(22) PCT Filed: Jan. 24, 2019
(86) PCT No.: PCT/EP2019/051770

§ 371 Date: Aug. 8, 2020

(30) Foreign Application Priority Data
Feb. 21, 2018 (DE) 10 2018 202 601.7

(51) Int. Cl. H02K 15/00; H02K 3/24; H02K 9/197

(52) U.S. Cl. CPC H02K 15/0006; H02K 9/197; H02K 3/24

(57) ABSTRACT

A method for repairing solder joint leakages on a connection unit designed to feed cooling water into hollow metallic stator bars of a stator winding of an electrical machine, wherein the connecting device includes a metallic bar-receiving body with a passage opening in which the stator bars are inserted, aligned using metallic spacers and connected fluid-tightly to the bar-receiving body and to the spacers by substance bonding using a solder. The free ends of the stator bars terminate substantially flush with the free ends of the spacers and with an end face of the bar-receiving body. A cup-like metallic cover element surrounds and connects the free ends of the stator bars fluid-tightly to the bar-receiving body by substance bonding so as to form a cooling water chamber. A metallic cooling water line connection is provided on the cover element and connected fluid-tightly to the cooling water chamber.

### CROSS REFERENCE TO RELATED APPLICATIONS

This application is the US National Stage of International Application No. PCT/EP2019/051770 filed 24 Jan. 2019, and claims the benefit thereof. The International Application claims the benefit of German Application No. DE 10 2018 202 601.7 filed 21 Feb. 2018. All of the applications are incorporated by reference herein in their entirety.

### FIELD OF INVENTION

The present invention concerns a method for repairing solder joint leakages on a connecting device which is designed to feed cooling water into hollow metallic stator bars of a stator winding of an electrical machine, wherein the connecting device comprises: a metallic bar-receiving body with a passage opening in which the stator bars are inserted, aligned using metallic spacers and connected fluid-tightly to the bar-receiving body and to the spacers by substance bonding using a solder, wherein the free ends of the stator bars terminate substantially flush with the free ends of the spacers and with an end face of the bar-receiving body, a cup-like metallic cover element which surrounds and connects the free ends of the stator bars fluid-tightly to the bar-receiving body by substance bonding so as to form a cooling water chamber, and a metallic cooling water line connection which is provided on the cover element and connected fluid-tightly to the cooling water chamber.

### BACKGROUND OF INVENTION

Connecting devices of the type cited initially are known in the prior art. They are used for example in generators in order to conduct cooling water into the hollow stator bars of a stator winding. An example of such a generator is generator type SGENS-3000W by Siemens AG.

The bar-receiving body provided with a passage opening may for example be made of copper and be provided in the form of a square tube. The free end regions of the stator bars leading to the stator winding are inserted in the passage opening of the bar-receiving body, and aligned inside the opening using metallic spacers which are also preferably made of copper. The stator bars, the spacers and the bar-receiving body are connected together fluid-tightly by substance bonding using a solder so as to produce a monolithic unit, so that cooling water can only pass through the hollow stator bars from one end face of the bar-receiving body to the other end face. The substance-bonded solder connection is normally produced by covering the surfaces of the components to be joined with a solder, and after corresponding alignment, being soldered by induction in a suitable soldering device. A cup-like metallic cover element, which may also be made of copper, is placed over the end faces of the bar-receiving body at which the free ends of the stator bars and free ends of the spacers terminate substantially flush. The cover element surrounds the free ends of the spacers and is connected fluid-tightly to the bar-receiving body by substance bonding so as to form a cooling water chamber. A metallic cooling water pipe connection, which is connected fluid-tightly to the cooling water chamber, is provided on the cover element and connected fluid-tightly to a cooling water reservoir. Accordingly, during operation of the generator, cooling water can be conducted via the cooling water pipe connection into the cooling water chamber, and from there into the individual stator bars so that these undergo cooling.

A problem with the structure of the connecting device described above is in practice that the tightness of the solder joints connecting together the stator bars, spacers and bar-receiving body by substance bonding can deteriorate, leading to undesirable cooling water leakages. The cause of the deteriorating tightness is usually that, starting from gaps present in the solder joints which may be created during the production process of the connecting device, cracks can be induced and propagate, in particular because of gap corrosion.

In this context, it is known that connecting devices of the type cited initially need regular maintenance or repair in order to guarantee proper operation of the generator. At present, repair takes place exclusively using the so-called resin drawing method. In this method, in a first step liquid resin is applied to the end face of the bar-receiving body opposite the cover element. In a second step, a vacuum is created in the cooling water chamber which causes the resin to penetrate into the cracks which extend continuously from the cooling water chamber through to the external end face of the bar-receiving body, whereby a seal is achieved.

Although the resin drawing method has proved successful in the past, it nonetheless has disadvantages. The most serious disadvantage is that it is only possible to seal cracks which are already causing a cooling water leakage, i.e. cracks which connect the cooling water chamber to the environment. Existing leakages can indeed be eliminated. For cracks which will only lead to leakage in the near future however, sealing is not possible. In this context, it cannot be excluded that new leakages will occur shortly after performing a maintenance or repair of the type described above.

### SUMMARY OF INVENTION

On the basis of the prior art, it is an object of the present invention to provide an improved method for repairing solder joint leakages on a connecting device of the type described initially.

To achieve this object, the present invention provides a method of the type cited initially which comprises the steps: a) removal of the cover element from the bar-receiving body, b) overwelding of all solder joints which have become accessible by removal of the cover element and which connect the stator bars, the spacers and the bar-receiving body together by substance bonding, and c) fluid-tightly attaching the cover element removed in step a) or a new cover element to the bar-receiving body by substance bonding.

In other words, the present invention proposes sealing all solder joints, which are already the cause of leakages or at which future leakages could occur, by overwelding with a filler material. In this way, a leak-free operation of the electrical machine, which is in particular a generator, can be guaranteed at least until the next service interval.

Advantageously, the solder joints to be overwelded are cleaned before performance of step b). Cleaning may take place in particular as part of a grinding process and/or using suitable cleaning agents. Thus the quality of the weld process performed in step b) is improved.

Preferably, for performance of step b), a laser welding process with welding filler material is used. The laser welding process is distinguished firstly in that very fine weld beads can be created. In this way, it can be ensured that the openings of the hollow stator bars are not clogged with welding filler materials. Secondly, the laser welding process is advantageous in that only little heat is introduced into the component to be welded. Accordingly, damage to components of the electrical machine which are thermally connected to the bar-receiving body can be prevented, such as for example the insulation which surrounds the stator bars emerging from the bar-receiving body.

Advantageously, the welding beads extending in the transitional region between the stator bars and the spacers have a maximum width of 3 mm.

### BRIEF DESCRIPTION OF THE DRAWINGS

Further features and advantages of the method according to the invention will become clear from reading the following exemplary description with reference to the attached drawing. The drawing shows:

FIG. 1 a diagrammatic, partially cutaway view of a connecting device;

FIG. 2 a front view of a bar-receiving body in the connecting device, in the direction of arrow II of FIG. 1;

FIG. 3 a front view of the arrangement shown in FIG. 1 after performance of a first step of the method according to an embodiment of the present invention;

FIG. 4 a view of the bar-receiving body in the direction of arrow IV in FIG. 3, after performance of a second method step; and

FIG. 5 a diagrammatic, partially cutaway view of the connecting device after performance of the final method step.

### DETAILED DESCRIPTION OF INVENTION

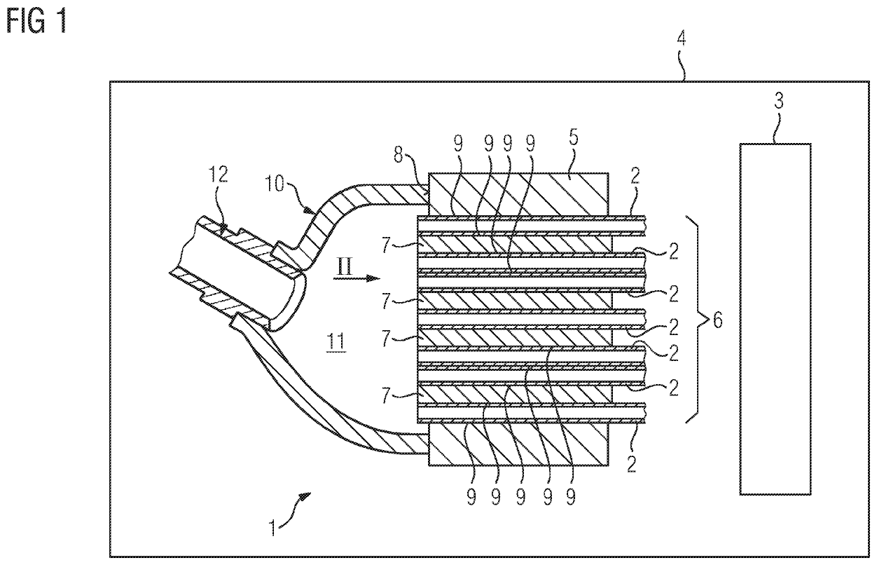

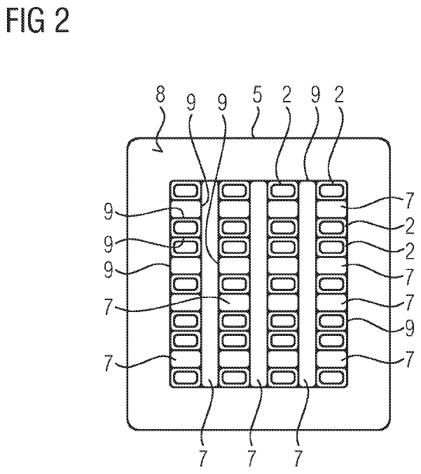

FIGS. 1 and 2 show views of a connecting device 1. This is designed to conduct cooling water from a cooling water reservoir or cooling water circuit (not shown in detail) into hollow metallic stator bars 2 of a stator winding 3 of an electrical machine 4, which in the present case may be a generator. The connecting device 1 comprises a metallic bar-receiving body 5, advantageously made of copper, with a passage opening 6 which in the present case has a rectangular cross-section. The end regions of the stator bars 2 leading to the stator winding 3 are inserted in the passage opening 6, and arranged and aligned using metallic rod-like spacers 7, which are also made of copper, such that the free ends of the stator bars 2 terminate substantially flush with the free ends of the spacers 7 and with an end face 8 of the bar-receiving body 5. The stator bars 2, the spacers 7 and the bar-receiving body 5 are connected together fluid-tightly by substance bonding using a solder, wherein the resulting solder joints are marked with reference sign 9. Accordingly, in principle a fluid can only pass through the bar-receiving body 5 via the cavities of the stator bars 2. The connecting device 1 furthermore comprises a cup-like metallic cover element 10 which is also advantageously made of copper. The cover element 10 is connected fluid-tightly to the bar-receiving body 5 by substance bonding and configured to surround the free ends of the stator bars 2 and the spacers 7 so as to form a cooling water chamber 11. A cooling water pipe connection 12, in the present case made of stainless steel, is arranged on the cover element 10 and connected fluid-tightly to the cooling water chamber 11, and leads to a cooling water reservoir or cooling water circuit (not shown in more detail). Accordingly, cooling water can be supplied to the cooling water chamber 11 via the cooling water connection 12 and conducted into the respective stator bars 2 in order to cool the stator winding 3.

In order to eliminate existing leaks in the region of the solder joints 9 or to prevent the occurrence of such leaks, which are usually caused by production-induced gaps inside the solder joints 9 from which cracks caused by gap corrosion propagate, the method described below according to one embodiment of the present invention is carried out:

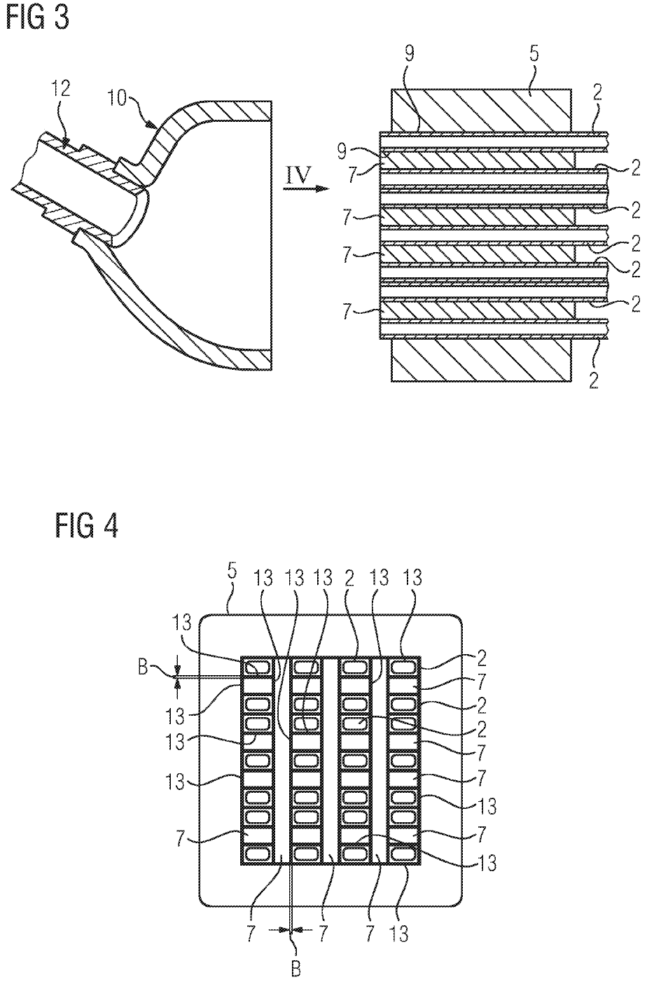

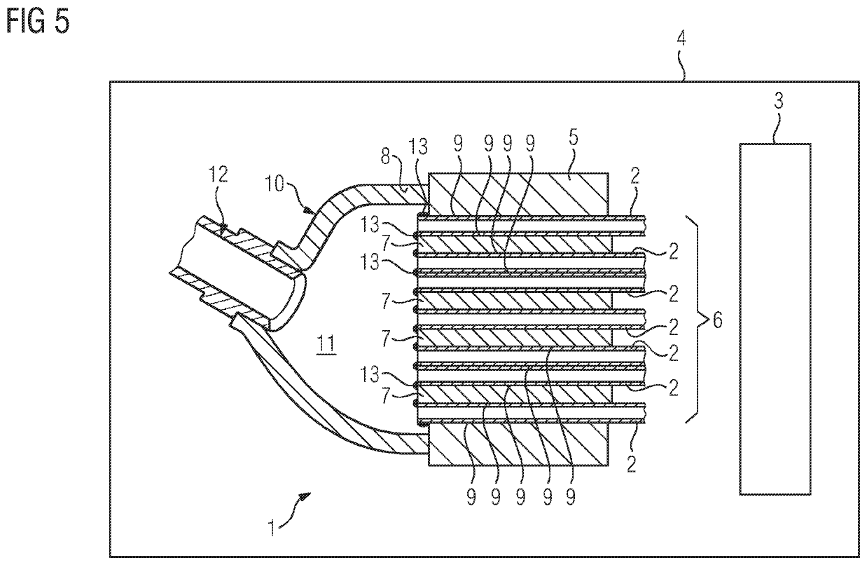

In a first step, the cover element 10 is removed from the bar-receiving body 5 as shown in FIG. 3, for example by unsoldering. Then the solder joints 9, which have become accessible by removal of the cover element 10, are advantageously cleaned, for which a grinding process and/or suitable cleaning agents may be used. In a further step, all solder joints 9 which connect the stator bars 2, the spacers 7 and the bar-receiving body 5 together by substance bonding, are overwelded. The weld beads 13 produced during this welding process are shown in FIG. 4, and have a maximum width B of 3 mm in the transitional region between the stator bars 2 and spacers 7. A suitable welding process is in particular the laser welding process with suitable welding filler material. This is advantageous in that narrow weld beads 13 can be produced with comparatively little heat delivery. Accordingly, there is only a low risk that the cavities of the stator bars 2 will become clogged with welding filler material, or that further components of the electrical machine 4, which are situated close to the weld point or thermally connected thereto, will be damaged. This applies in particular to insulation which normally surrounds the stator bars guided out of the bar-receiving body 5. In a last step, the cover element 10 removed in the first step is reattached fluid-tightly to the bar-receiving body 5 by substance bonding, in particular soldered thereto as shown in FIG. 5. The cover element 10 may first be cleaned and/or repaired if necessary. Alternatively, the cover element 10 may be replaced by a new cover element.

The method described above is advantageous in particular in that, as well as eliminating existing leaks in the region of the solder joints 9, the occurrence of new leaks may be prevented at least until the next maintenance cycle.

Although the invention has been illustrated and described in detail by the exemplary embodiment, the invention is not restricted by the examples disclosed and other variations may be derived therefrom by the person skilled in the art without leaving the scope of protection of the invention.

1. A method for repairing solder joint leakages on a connecting device which is designed to feed cooling water into hollow metallic stator bars of a stator winding of an electrical machine, wherein the connecting device comprises:
a metallic bar-receiving body with a passage opening (6) in which the stator bars are inserted, aligned using metallic spacers and connected fluid-tightly to the bar-receiving body and to the spacers by substance bonding using a solder, wherein free ends of the stator bars terminate substantially flush with the free ends of the spacers and with an end face of the bar-receiving body,
a cup-like metallic cover element which surrounds and connects the free ends of the stator bars fluid-tightly to the bar-receiving body by substance bonding so as to form a cooling water chamber, and
a metallic cooling water line connection which is provided on the cover element and connected fluid-tightly to the cooling water chamber,
wherein the method comprises:
a) removal of the cover element from the bar-receiving body,
b) overwelding of all solder joints which have become accessible by removal of the cover element and which connect the stator bars, the spacers and the bar-receiving body together by substance bonding, and
c) fluid-tightly attaching the cover element removed in step a) or a new cover element to the bar-receiving body by substance bonding.

2. The method as claimed in claim 1,
wherein the solder joints to be overwelded are cleaned before performance of step b).

3. The method as claimed in claim 1,
wherein for performance of step b), a laser welding process with welding filler material is used.

4. The method as claimed in claim 1,
wherein welding beads which extend in a transitional region between the stator bars and the spacers have a maximum width of 3 mm.
